(19) United States
(12) Patent Application Publication
(10) Pub. No.: US 2023/0334481 A1
(43) Pub. Date: Oct. 19, 2023

(54) SOCIAL MEDIA UNIVERSAL PAYMENT METHOD AND SYSTEM

(71) Applicant: Liming Zhang, Coto De Caza, CA (US)

(72) Inventor: Liming Zhang, Coto De Caza, CA (US)

(21) Appl. No.: 17/802,942

(22) PCT Filed: Nov. 29, 2021
(86) PCT No.: PCT/US2021/060975

§ 371 Date: Aug. 26, 2022

Related U.S. Application Data
(60) Provisional application No. 63/119,894, filed on Dec. 1, 2020.

(51) Int. Cl. G06Q 20/38; G06Q 20/02; G06Q 20/40; G06Q 20/10

(52) U.S. Cl. CPC G06Q 20/384; G06Q 20/02; G06Q 20/102; G06Q 20/401

(57) ABSTRACT

A computer-implemented method and system for performing online and offline financial transactions universally between any two users through a third party’s authentication mechanism to verify users’ identities, provided that they have at least a social media account. One user can make any payment to anyone. The SMUP system accesses the third-party’s website for credentials authentication. SMUP can be used for a purchase or money transfers with a live internet connection. The user needs to remember only one account credentials instead of many. One user can be a merchant or organization; wherein one of the users may not previously be a SMUP user, the user may passively become a SMUP user during the transaction. The above financial transactions may also happen online or offline at a physical store where a POS machine is used; the store is a SMUP user or partner, and the POS is connected with the SMUP transaction server.

### CROSS-REFERENCE TO RELATED APPLICATIONS

This application is the U.S. National Stage Utility Pat. application, filed under 35 U.S.C. § 371, of International Patent Application No. PCT/CA2021/060975, or International Publication Number WO2022/119767A1, filed on NOV 29, 2021, with a priority date of DEC 01, 2020. The entire disclosure of the above application is incorporated herein by reference.

### FIELD

The present disclosure is in the field of information technology, electronic payment technology, financial transactions, secured transactions between users, authentication of users involved in financial transactions, and especially, a social media-based universal payment method and system that performs online and offline financial transactions universally between any two users by using a third party’s authentication mechanism to verify the users’ identities.

### BACKGROUND

In today’s trend, mobile phones and other mobile devices are items that most people carry with them at all times. They are electronic communications devices that stay connected to the Internet while typically supporting multiple wireless communications mechanisms and technologies, such as GSM, LTE, and 5G. People use social networks, which are internet-based social media sites, to stay connected with friends, family members, colleagues, customers, or clients. Social networking can have a social purpose, a business purpose, or both through sites such as Facebook, Twitter, Linkedln, and Instagram, among others.

In a non-limiting example, a user performs an online or offline transaction (offline with or without a network connection) with another user or an entity, e.g., merchant, store, institution, restaurant, etc., using a bank’s credit or debit card on a PC or mobile phone, or at a local point of sale (POS) machine. To complete the transaction, the user needs either a physical card or authentication information, such as a CVV code, online password, security questions, tokens, etc. There’s a slew of cybersecurity methods out there: identity verification, multi-factor authentication, knowledge-based authentication, etc.

The online ecosystem of identity management is a flexible and interactive system that makes it possible to establish and manage digital identities. These are critical in acting as authentic proofs of identity for accessing modern sharing systems and performing transactions using e-commerce platforms, digital banking, and more. Accurate authentication of the identities of the users or entities engaged in secure transactions or activities to access secure computer applications, networks, systems, and devices is a problem that continues to grow.

If a group of users, e.g., friends, co-workers, etc., wants to transfer money among themselves, the existing transaction mechanisms require the transferor and the transferee to be registered/affiliated with a financial institution for transferring the money. Suppose the transferor is affiliated with financial institution A, and the transferee is affiliated with financial institution B or with no financial institute at all. In that case, the transfer is impossible without incurring additional costs and extra verification steps. Not all users find it easy to remember authentication information, such as password, CVV code, security questions, etc., for all their accounts. It is a matter of inconvenience and can be difficult to memorize if there is a lot of authentication information to remember. Financial transactions requiring multiple authentication mechanisms are becoming increasingly common, making the experience increasingly difficult, less user-friendly, confusing, and inconvenient for users. Moreover, these mechanisms become less dependable when an authentic user cannot authenticate himself because of the inherent difficulties and complexities.

In a non-limiting example, a person purchases a few items online on Walmart, Amazon, and Home Depot’s website and pays using a Mastercard, Visa credit card, and American Express credit card, respectively. That person either needs to create an account on each online store or use them as a guest. Creating the account provides advantages, such as personalized settings, loyalty programs, history, ease of tracking the order, faster checkout, etc. However, the person has to memorize usernames, passwords, security questions, verification codes, etc., for three different online accounts. Even when purchasing online as a guest, the person still needs to know and input information from the three credit cards. If the person makes an in-store purchase, they still need to bring and provide the information from the three credit cards. That requires remembering credentials about six different products, i.e., three online accounts & three credit cards.

Opportunities in digital identity management rely on finding the right solution for the right user and extending a helpful hand in dispute management. Services must be developed with a customer-centric approach in mind and be standardized according to security standards. In the long run, online and offline identity verification tools must deliver usability in the following areas: universally operate among heterogeneous users belonging to very different networks or groups; complete transaction in both online and offline situations; quickly and accurately check digital identities; provide users with data security and ownership; perform repeated verifications for consistency; safeguard against potential cybersecurity threats; and, provide risk and compliance management for business growth. It all boils down to striking a balance between data management and identity needs while keeping in mind customer sensitivities regarding data privacy and customers’ distaste of extra steps required for verification. Thus, there is a need for a universally working, accurate, reliable, flexible, and user-friendly user identification method for enabling easy financial transactions between users and entities.

### SUMMARY

The present disclosure presents embodiments of a Social Media Universal Payment (SMUP) method and system that performs online and offline financial transactions universally between any two users through a third party’s authentication mechanism to verify the users’ identities. You can use SMUP method and system to make any payment to anyone. All you need is a social media account on any social media network. If the social media account does not have a financial payment function, you also need a bank account to make the payment possible. Once you start to use the SMUP system, it creates a SMUP account for you on the SMUP server. The SMUP system can use the social media account or any other third party’s credentials for identity verification. The user authorizes the SMUP system to retrieve login credentials from the third-party server. The SMUP system accesses the third-party’s website/system and retains information about the third party in the SMUP server. The third-party’s website/system verifies the identity of the user. For example, when paying for a purchase using the SMUP system, whether online or in-person at the store, the user is prompted to select the third-party retained in the SMUP server and to enter the third party’s credentials, e.g., username and password, for identification. The person inputs the credentials that are validated by the third party’s authentication server. The user also provides financial information for transactions. For example, the user provides a bank account’s transit number/account number for direct payment/deposit, credit card’s number, PIN, CVV code, etc. The information about the bank/credit card company is stored in the SMUP server. A plurality of third-party credentials and financial information from numerous credit cards/bank accounts may be used for each account.

If the person makes a purchase or transfers money using the SMUP system with a live internet connection, the SMUP system prompts the user to enter a third party’s credentials. Once the user inputs this information, it is instantaneously verified from the third party’s website/system. Once this information is verified, the user is prompted to select the credit card for payment. Once the user selects the credit card, the money is transferred from one account to another. There is no need to input information about the credit card or bank account every time they make a purchase. Thus, the user only needs to remember a single third party’s credentials, instead of six or three as discussed above, for carrying out any number of financial transactions. The above financial transactions may be conducted between two users, or between a user and a merchant or organization, wherein one of the users may not previously be a SMUP user. In this case, the user may then passively become a SMUP user during the transaction. The merchant or organization can already be a SMUP user or partner. The above financial transactions may also be conducted online or offline at a physical store where a POS (point of sale) machine is used. The store is a SMUP user or partner, and the POS is connected with the SMUP server. During an offline POS transaction, the user may not have previously registered as a SMUP user. The user may then passively become a SMUP user during this transaction. The above financial transactions may be conducted between two users, wherein one of the users is temporarily disconnected from the internet. In this case, the user connected to the internet needs to have operational SMUP software installed. This facilitates verifying both parties’ user credentials. The account and transaction information is then exchanged with the SMUP server to complete the transaction.

There can be a situation where two parties want to do a transaction but are not connected to the SMUP server. In this case, both parties need to be SMUP users and have the SMUP software/app program installed on their devices. The SMUP software/app program stores a most recent snapshot of both users’ SMUP account balances. The installed program on one party’s device facilitates the creation of a code, e.g., QR code, that can be shown and scanned by another party’s device. The QR code may be a payment code that shows the party’s identity and intent to pay. The QR code may be a collection code that shows one party’s intent to collect money from another paying party and that party’s identity. The software/app program is adaptable to scan these codes and verify the authenticity of the other party. Once the identification is verified and the parties authorize the transaction, the remaining balance changes. A receipt is generated at the end of the transaction. This receipt is used as proof of purchase by the parties. Either party may go online, get connected to the SMUP server, and upload the buffered balance and receipt for the completion of the transaction. Once the SMUP server receives the proof of purchase, money is transferred from one account to another.

The SMUP system enables the user to perform transactions, regardless of the user’s live connection with the SMUP server. In other words, the user only needs to remember the credentials of a single third party, instead of six or three, as discussed above, for carrying out any number of financial transactions even if neither party of the transaction is connected to the SMUP server during the transaction.

### BRIEF DESCRIPTION OF THE DRAWINGS

The accompanying drawings, which are included to provide a further understanding of the invention and are incorporated in and constitute a part of this application, illustrate embodiment(s) of the present disclosure and, together with the description, serve to explain the principle of the invention. For simplicity and clarity, the figures of the present disclosure illustrate a general manner of construction of various embodiments. Descriptions and details of well-known features and techniques may be omitted to avoid unnecessarily obscuring the discussion of the present disclosure’s described embodiments. It should be understood that the elements of the figures are not necessarily drawn to scale. Some elements’ dimensions may be exaggerated relative to other elements for enhancing the understanding of described embodiments. In the drawings:

FIG. 1 is a block diagram of an embodiment of the Social Media Universal Payment (SMUP) system of this disclosure for performing financial transactions involving financial/commercial entities and users;

FIG. 2 is a block diagram of an embodiment of the Social Media Universal Payment (SMUP) system of this disclosure for performing financial transactions between users;

FIG. 3 is a block diagram of the Social Media Universal Payment (SMUP) system of this disclosure for performing financial transactions between financial/commercial entities and users;

FIG. 4 is a sequence diagram of a financial transaction performed according to the embodiment shown in FIG. 2;

FIG. 5 is a flow diagram of the financial transaction performed according to the embodiment shown in FIG. 2;

FIGS. 6-7 are sequence diagrams of financial transactions performed according to the embodiment shown in FIG. 3;

FIG. 8 is a flow diagram of the financial transactions performed according to the embodiment shown in FIG. 3;

FIGS. 9-11 are sequence diagrams of financial transactions performed according to the embodiment shown in FIG. 3, wherein at least one party is not connected to the SMUP server at the time of the financial transaction;

FIG. 12 is a block diagram of a SMUP system of this disclosure with details of a user’s device and a commercial entity’s (e.g., merchant) point of sale (POS) machine; and

FIG. 13 is a block diagram showing details of a SMUP server according to this disclosure.

### DETAILED DESCRIPTION

The present disclosure generally relates to a Social Media Universal Payment (SMUP) method and system that may take various forms. Various examples of the present invention are shown in the figures. However, the present invention is not limited to the illustrated embodiments. In the following description, specific details are mentioned to give a complete understanding of the present disclosure. However, it may likely be evident to a person of ordinary skill in the art; hence, the present disclosure may be applied without mentioning these specific details. The present disclosure is represented as a few embodiments; however, the disclosure is not necessarily limited to the particular embodiments illustrated by the figures or description below.

The language employed herein only describes particular embodiments; however, it is not limited to the disclosure’s specific embodiments. The terms “they”, “he/she”, or “he or she” are used interchangeably because “they”, “them”, or “their” are considered singular gender-neutral pronouns. The terms “comprise” and/or “comprising” in this specification are intended to specify the presence of stated features, steps, operations, elements, and/or components. However, they do not exclude the presence or addition of other features, steps, operations, elements, components, or groups.

Unless otherwise defined, all terminology used herein, including technical and scientific terms, have the same definition as what is commonly understood by a person of ordinary skill in the art, typically to whom this disclosure belongs. It will be further understood that terms, such as those defined in commonly used dictionaries, should be interpreted as having the same meaning as defined in the context of the relevant art and the present disclosure. Such terms should not be construed in an overly strict sense unless explicitly described herein. It should be understood that multiple techniques and steps are disclosed in the description, each with its individual benefit. Each technique or step can also be utilized in conjunction with a single, multiple, or all of the other disclosed techniques or steps. For brevity, the description will avoid repeating each possible combination of the steps unnecessarily. Nonetheless, it should be understood that such combinations are within the scope of the disclosure. Reference will now be made in detail to some embodiments of the present invention, examples of which are illustrated in the accompanying figures.

To overcome the limitations of the prior art, the present disclosure discloses methods and systems to implement the Social Media Universal Payment (SMUP) system. The SMUP method performs online and offline financial transactions universally between any two users through a third party’s authentication mechanism to verify the users’ identities. The SMUP allows you to make any payment to anyone, provided you and the payee have at least one third-party account. The third-party account can be any social media network account. If the third-party account does not have a financial payment function, you need a bank account to make the payment possible. The SMUP eliminates the need for repetitive identity verification and a multitude of authentication mechanisms. Nowadays, users are increasingly using social media platforms to interact with each other and do financial transactions, such as buying an item advertised on the social media platform from another entity, such as a merchant. Both parties involved in the transaction eventually need to be registered with the SMUP system for completing the transaction initiated by the user. However, only one user is initially required to have a SMUP account. The SMUP system makes the user independent of any specific social media platform, and the users do not need to bind their credit cards to any specific social media platform. The SMUP system borrows the users’ account information about the social media platform to authenticate and identify the users. Open standard OAuth 2.0 or equivalent authorization protocols are used to verify users’ identification credentials without giving out the passwords. The SMUP system does not store identification credentials, e.g., password, username, CVV, of the users. Instead, the SMUP system uses various social media platforms or third parties to verify the identity of the users for completing a financial transaction. Users can also make payments and transfer money across various social media platforms, e.g., between users of different social media networks.

A merchant may choose to partner with the SMUP system and register to become a SMUP system merchant, i.e., another type of SMUP user. The SMUP system registers a merchant after verifying the merchant’s identity to prevent fraud. The merchant may show a state-issued business license to prove that the merchant is legally permitted to perform business operations in a specific jurisdiction. Alternatively, the merchant may show supplier invoices/receipts from a wholesaler of items, which the merchant is retailing. The supplier invoices/receipts should include the supplier’s business name, business address, email address, and telephone number for identity verification. This information is used to create the merchant’s account profile. The merchant’s profile may include the merchant’s website, customer support email, customer support website, and FAQ website. The SMUP system needs payment methods that are preferred by the merchant, including credit cards and bank accounts, to facilitate money transfer from the user to the merchant, and vice versa.

In order to register with the SMUP system, a user must provide identification credentials for verification and financial information for money transfer. The user authorizes the SMUP system to obtain the user’s identification credentials from the social media platform/third party. In other words, login information for the social media platform is used to verify the user’s identity. For example, the user is prompted to enter this information at the merchant’s website/point of sale (POS) machine to verify the user’s identity. The user needs to log into the social media platform to verify the identification credentials. If the user is using a mobile phone or laptop to make a purchase and is already logged into the social media account at the time of purchase, the user’s identification credentials would be automatically verified, and the user would not be prompted to enter the identification credentials. However, if the user is not logged into the social media account at the time of purchase, the user would be prompted to manually enter the identification credentials for verification. In another example, the user may use a form of biometric verification, such as facial recognition, retina scans, iris recognition, finger scanning, finger vein ID, voice identification, etc., to enter identification credentials for verification.

For identification purposes, the SMUP system allows the user to use a trusted third party, which includes, but is not limited to: a Google account, bank accounts, government institutions, credit reporting agencies, insurance companies, health care providers, etc. The third party includes trusted entities that have verified the user’s identity and have set up the user’s identification credentials that are used for verifying the user. The SMUP system enables the user to use identification credentials from a single third party to conduct financial transactions with every financial entity registered with the SMUP system. There is no need to remember authentication information, such as password, CVV code, security questions, etc., for many financial entities. In a non-limiting example, the user creates an account and registers by providing information from one social media platform (e.g., Facebook) and binds a plurality of credit/debit cards from various banks with that account.

KYC is short for Know Your Client. It is to confirm the user’s real identity. According to the different laws of each country, there are different requirements for KYC that force financial institutions to vet the people they are doing business with, ensuring the people’s identity, their financial activities, and the risk they pose. The SMUP system carries out a financial transaction in accordance with the laws of the relevant country and the requirements for KYC. According to any given country’s laws, after the KYC procedure, the user can transfer the money to another bank account or credit card. For example, users can transfer money to other people’s bank accounts or credit cards.

For money transfer, the user needs to provide information related to at least one credit card, debit card, or checking account from where money could be transferred to the other party involved in the financial transaction, e.g., merchant, another user, etc. The user may provide financial information related to several accounts for money transfer. The user selects the account of their choice among the several accounts for transferring money at the time of financial transaction. If the user provides information involving a credit card or a bank account for transferring money, that credit card or bank account should be bound to that user’s SMUP account.

Once the user has provided both the identification credentials for the user’s identity verification and the financial information for money transfer, the provided information is verified and the verification status stored in the SMUP system. The SMUP system stores the information related to the social media platform, third party, credit card, bank account, and prompts the user to select from the stored information at the time of transaction. The user is then considered registered with the SMUP system. If either piece of the required information is not provided by the user or the information is not verified or stored in the SMUP system, the user is not considered registered. If the user is not registered, a financial transaction cannot be completed. Suppose the SMUP system receives a request for identification verification of a new user who is not registered. In that case, the SMUP system first prompts that user to provide identification credentials for verification. The automatic and manual means of verification of the identification credentials are described above. If the SMUP system receives a verification request for a user wherein the system has neither the identification credentials nor the financial information, that user is considered new and the registration non-existent. If the SMUP system only has either the identification credentials or the financial information, then the user’s registration is considered incomplete.

Once these credentials are provided and verified, the user is prompted to provide the required financial information for the money transfer. In some embodiments, the SMUP system prompts the user to provide the identification credentials and the financial information before verifying any one of them. Once both pieces of the required information are provided, it is verified to register the user. It is essential that the SMUP system receives and verifies both pieces of the provided information. The order in which the SMUP receives or prompts the user to provide that information is not significant for this disclosure.

A user may use their credit card to pay for an item purchased at a store. In the existing identity verification mechanisms, the user’s identification credentials are sent to the identity verification mechanism (e.g., credit card server) that checks and verifies the user’s identification credentials using the information in a database. Thus, a connection/link between the identity verification requestor and the existing identity verification mechanism must be established when a financial transaction is performed. In other words, a live connection/link is required for the completion of the financial transaction. In contrast, the SMUP system can carry out identity verification for a financial transaction without the live connection/link. In addition, the SMUP system enables the transaction to be conducted in either an online or offline setting. Online transactions are generally performed on a PC, mobile phone, or any other device that can access the merchant’s website. In contrast, offline transactions are not performed on the merchant’s website. Non-limiting examples of offline transactions are when the user goes to a store or restaurant and uses a QR code for payment at that store or restaurant.

In a non-limiting embodiment of the SMUP system, the need for a live connection/link may be eliminated by installing a program/software on the user’s mobile phone, as well as the merchant’s POS or website. If neither party is connected to the SMUP server, both parties involved in the transaction need to have the program/software installed on their respective devices. The program/software may be in the form of a plugin. In a non-limiting example, the program/software generates a QR code containing data about the user’s identity credentials. The merchant scans the QR code. The program/software installed on the merchant’s POS or website can retrieve and verify identity credentials based on the QR code. Suppose a financial transaction is performed without a live connection/link. In that case, the financial transaction threshold limit may be lowered compared to the threshold limit when the live connection/link is available.

The user must also provide information related to a financial institution to facilitate money transfer from the user to the merchant, and vice versa. For example, the user may provide a credit card, debit card, or checking account information of one or more financial institutions. If the user has provided information from multiple financial institutions, the user may choose the financial institution at the time of the transaction.

If the person makes a purchase or transfers money using the SMUP system with a live internet connection, the SMUP system prompts the user to enter a third party’s credentials. Once the user inputs this information, it is instantaneously verified from the third party’s website/system. Once this information is verified, the user is prompted to select the credit card for payment. Once the user selects the credit card, the money is transferred from one account to another. There is no need to input information about the credit card or bank account every time they make a purchase. Thus, the user only needs to remember credentials from a single third party, instead of six or three, as discussed above, for carrying out any number of financial transactions. The above financial transactions may be conducted between two users or between one user and a merchant or organization, wherein one of the users may not previously be a SMUP user. In that case, the user then passively becomes a SMUP user during the transaction. The merchant or organization can already be a SMUP user or partner. The above financial transactions may also be conducted online or offline at a physical store where a POS (point of sale) machine is used. The store is a SMUP user or partner, and the POS is connected with the SMUP transaction server. During an offline POS transaction, the user may not have previously registered as a SMUP user; the user may then passively become a SMUP user during this transaction. The above financial transactions may be conducted between two users, wherein one of the users is temporarily disconnected from the internet. In this case, the user that still has an internet connection needs to have operational SMUP software installed. After verifying both parties’ user credentials, the account and transaction information can be exchanged with the SMUP server to complete the transaction.

There can be a situation where two parties want to do a transaction but are not connected to the SMUP server. In this case, both parties need to be SMUP users and have the SMUP software/app program installed on their devices. The SMUP software/app program stores a most recent snapshot of both users’ SMUP account balances. The installed program on one party’s device facilitates creating a code, e.g., QR code, that can be shown and is scanned by another party’s device. The QR code may be a payment code that shows the party’s identity and intent to pay. The QR code may be a collection code that shows one party’s intent to collect money from another paying party and that party’s identity. The software/program is adaptable to scan these codes and verify the authenticity of the other party. Any person skilled in the art would understand that the software/program is adaptable to verify the identification credentials of both parties, even if the two parties are not connected to the SMUP server. Once the identification is verified and the parties authorize the transaction and account balance changes, a receipt is generated at the end of the transaction. This receipt is used as proof of purchase by the parties. Either party may go online, get connected to the SMUP server, and upload the buffered account balance and receipt for the completion of the transaction. Once the SMUP server receives the proof of purchase, money is transferred from one account to another.

The SMUP system enables the user to perform transactions, regardless of the user’s live connection with the SMUP server. In other words, the user only needs to remember the credentials of a single third party, instead of six or three, as discussed above, for carrying out any number of financial transactions even if neither party of the transaction is connected to the SMUP server during the transaction.

The SMUP system facilitates financial transactions between merchants and users or among various users by managing the identity verification and financial information of both parties involved in the financial transaction.

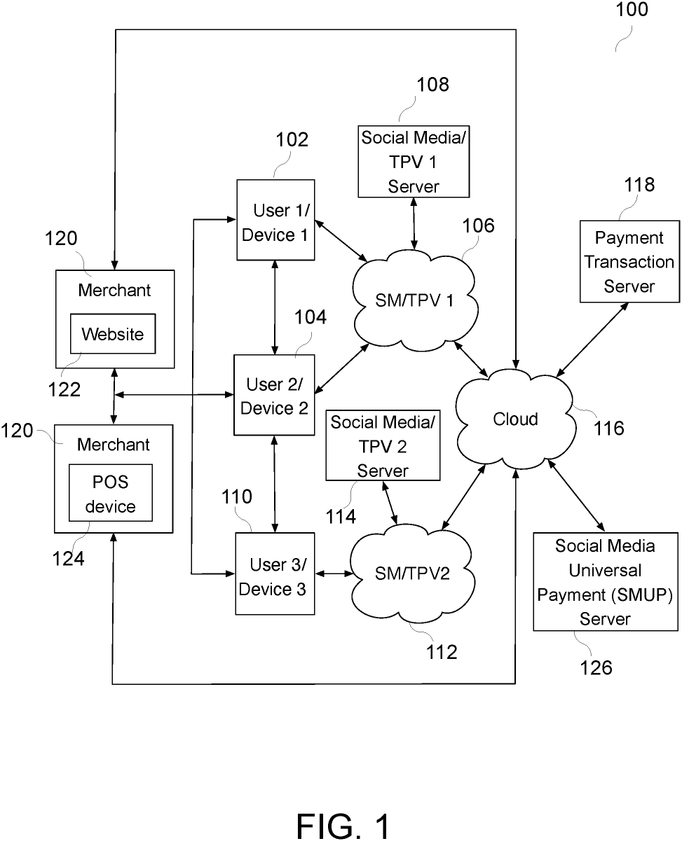

As noted above, FIG. 1 is a block diagram of an embodiment of the SMUP system (100). A financial entity, such as a merchant (120), has a website (122) that the users/devices (102, 104, 110) access to conduct online transactions, such as the purchase of an item. Hereinafter, the term user/device (the element “102” or other such terms used in this disclosure) can also represent a user, an account associated with the user, or a device used by the user. The users (102, 104, 110) can also visit the brick-and-mortar stores of the merchant (120) to purchase an item, wherein the financial transaction is performed using a point of sale (POS) device (124). Users/devices 1 and 2 (102, 104) are affiliated with the social media (SM) platform/third party verifier (TPV) 1. Users/devices 1 and 2 (102, 104) are connected to the SM/TPV 1 server (108) via the SM/TPV 1 cloud (106). Another user, identified as User 3 (110), is affiliated with the SM/TPV 2 and is connected to the SM/TPV 2 server (114) via the SM/TPV 2 cloud (112). User 1 (102) and user 2 (104) use device 1 and device 2, respectively, to access the SM/TPV 1 server (108) via the SM/TPV 1 cloud (106). User 3 (110) accesses the SM/TPV 2 server (114) via the SM/TPV 2 cloud (112).

Social Media Universal Payment (SMUP) server (126) is connected to the SM/TPV 1 cloud (106) and he SM/TPV 2 cloud (112) via the main cloud (116). The payment transaction server (118) is connected to the SMUP server (126) via the main cloud (116). Once the parties’ identities in the financial transaction have been verified by the SMUP server (126), it instructs the payment transaction server (118) to authorize and facilitate money transfer from the user (102, 104, 110) to the merchant (120). The SMUP server (126) receives an identity verification request from the merchant (120) via the main cloud (116). It accesses the SM/TPV 1 server (108) or SM/TPV 2 server (114) to obtain identification credentials and authorizes the financial transaction.

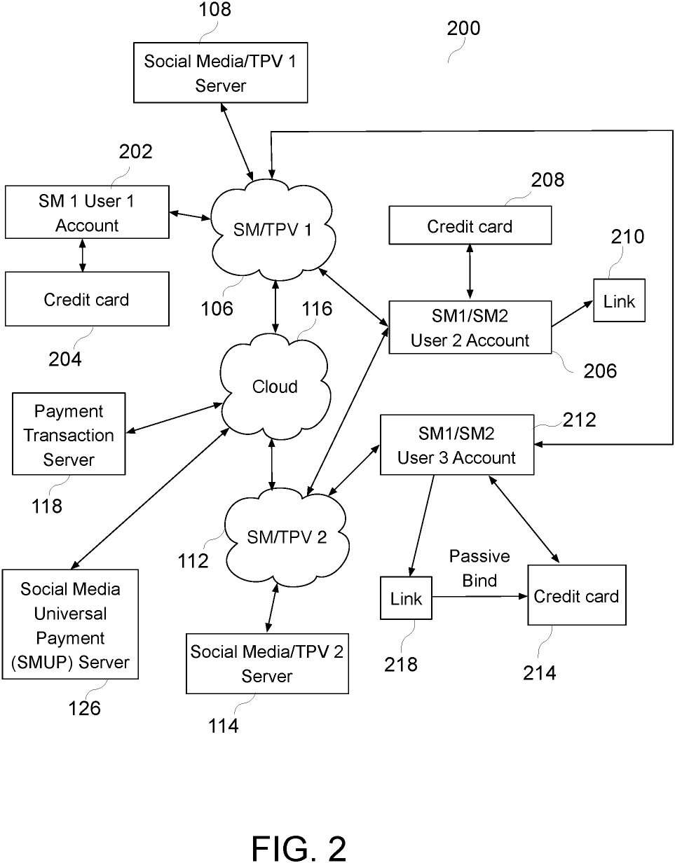

As noted above, FIG. 2 is the block diagram of an embodiment of the SMUP system (200) for performing financial transactions between users, i.e., wherein none of the parties involved is a merchant. The users may be individuals such as friends, social clubs, labor unions, people waiting at a bus stop, or even people waiting in line.

User 1 is affiliated with social media platform 1 and has an account; this account can be called user 1′s account (202). A credit card, identified as user 1′s credit card (204), is used by user 1 for financial transactions and is bound to user 1′s account (202). When user 1 authorizes and provides credit card (204) information for financial transactions, user 1′s credit card (204) is bound to user 1′s account (202). At least one credit/debit card or checking account may be bound to the user’s account. Although FIG. 2 shows only one credit card (204) bound to user 1′s account (202), accounts according to this disclosure may be bound with a plurality of credit/debit cards, checking, saving, or other suitable bank accounts. Although the disclosure refers to a credit card while discussing transactions, the credit cards as used in this disclosure include debit cards, checking, saving, or other suitable bank accounts. User 1′s account (202) is connected to the SM/TPV 1 server (108) via the SM/TPV 1 cloud (106).

User 2 is affiliated with social media platforms 1, 2, or both and has an account; this account can be called user 2′s account (206). A credit card, identified as user 2′s credit card (208), is bound to user 2′s account (206). User 1 wants to transfer money to user 2, and therefore, user 1′s account (202) sends a link (210) to user 2′s account (206). User 2 clicks on the link (210) to receive money. User 2′s credit card (208) is bound to user 2′s account (206), and therefore, the SMUP server (126) transfers money from user 1′s credit card (204) to user 2′s credit card (208).

User 3 is affiliated with social media platforms 1, 2, or both and has an account; this account can be called user 3′s account (212). User 1 wants to transfer money to user 3, and therefore, user 1′s account (202) sends a link (218) to user 3′s account (212). The user 3 clicks on the link (218) to receive the money. However, user 3′s account (212) does not have a bound credit card. The link (218) then prompts user 3 to bind their credit card (214) by providing information about that credit card (214). User 3 provides information about their credit card (214), which is then bound to user 3′s account (212). Once bound, the money from user 1′s credit card (204) is transferred to user 3′s credit card (214). The actions/steps undertaken to provide financial information for binding a credit card when the user/account does not have a bound credit card are part of a process called passive binding in this disclosure. The actions/steps undertaken to bind the credit card to the user/account before initiating a financial transaction are part of a process called active binding in this disclosure.

Credit cards bound to the various parties (202, 206, 212) involved in a financial transaction may belong to different banks and financial institutions. As noted above, the payment transaction server (118) authorizes and facilitates money transfer from one credit card to another credit card. Different banks and financial institutions may each have their own payment transaction server for handling transactions related to their bank or financial institution. Instead of showing a payment transaction server for each bank and financial institution, only one payment transaction server (118) is shown for simplicity in this disclosure. The payment transaction server (118) is responsible for authorizing and facilitating money transfers from all the different banks and financial institutions discussed herein.

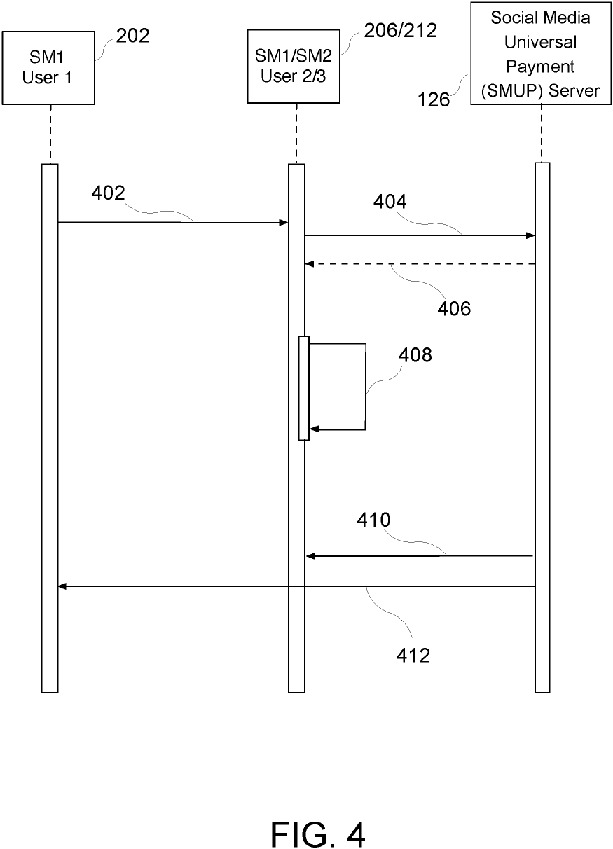

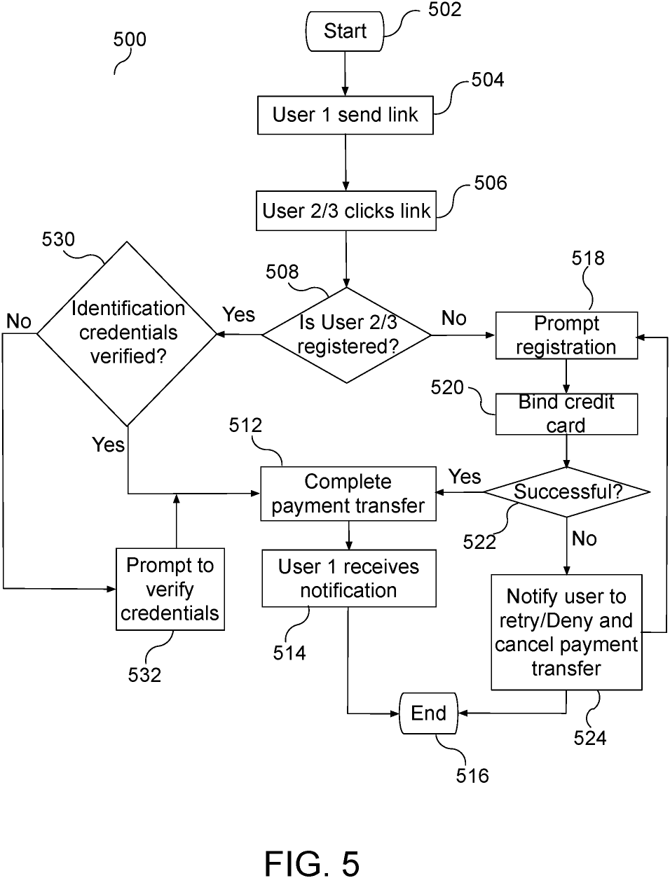

The accounts of user 2 and 3 (206, 212) may be connected to the SM/TPV 1 server (108) via the SM/TPV 1 cloud (106), to the SM/TPV 2 server (114) via the SM/TPV 2 cloud (112), or both to SM/TPV 1 server (108) and the SM/TPV 2 server (114) via their respective clouds (106,112). SM/TPV 1 cloud (106) and SM/TPV 2 cloud (112) is, in turn, connected to the main cloud (116). The SMUP server (126) and payment transaction server (118) are also connected to the main cloud (116). Financial transactions displayed in this figure (FIG. 2) are discussed below in detail in reference to FIGS. 4-5.

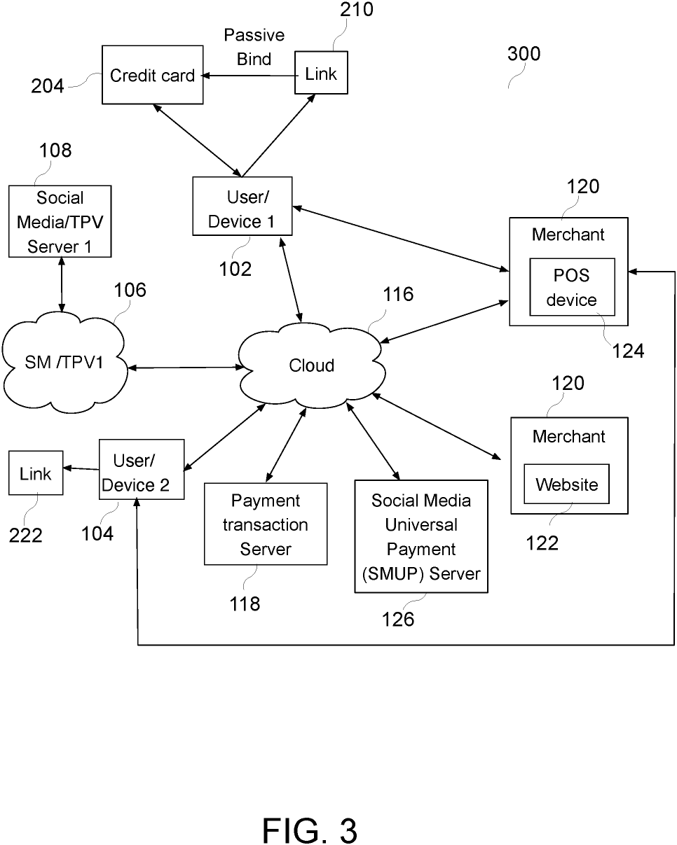

As noted above, FIG. 3 is a block diagram of the SMUP system (300) for performing financial transactions between the merchants and users. The merchant (120) has a website (122) to conduct online transactions, such as purchasing an item. Users 1 and 2 (102, 104) can also visit the merchant’s (120) brick-and-mortar store to purchase an item. As used in this disclosure, the term brick-and-mortar store means a physical place where products and services are offered to customers face-to-face in an office or store that the business owns or rents. A local grocery store and a retail shop are examples of brick-and-mortar companies.

User 1 (102) is affiliated with SM/TPV 1 that is used for identity verification of user 1 (102). User 1 (102), as shown in various figures of this disclosure, may use a device, such as a mobile phone, laptop, or desktop, to perform a financial transaction on the website (122) or at the merchant’s (120) store. As used herein, users (102, 104) also mean the SMUP accounts associated with the users (102, 104). As stated earlier, the element “102” or other such terms used in this disclosure may represent a user, an account associated with the user, or a device used by the user. User 1 (102) is connected to the main cloud (116) that is linked to the SM/TPV 1 server (108) via the SM/TPV 1 cloud (106). User 1 (102) receives a link (210) originating from the POS device (124) or the website (122) of the merchant (120) via the main cloud (116). User 1 (102), who is not registered, presses the link (210), which prompts user 1 (102) to passively bind their credit card (204) with the user’s (102) account.

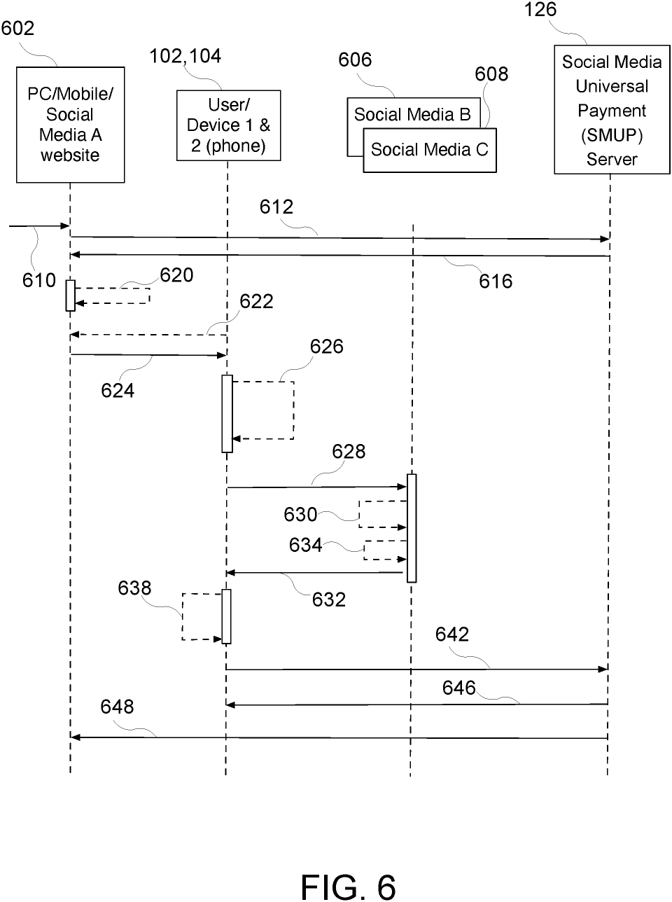

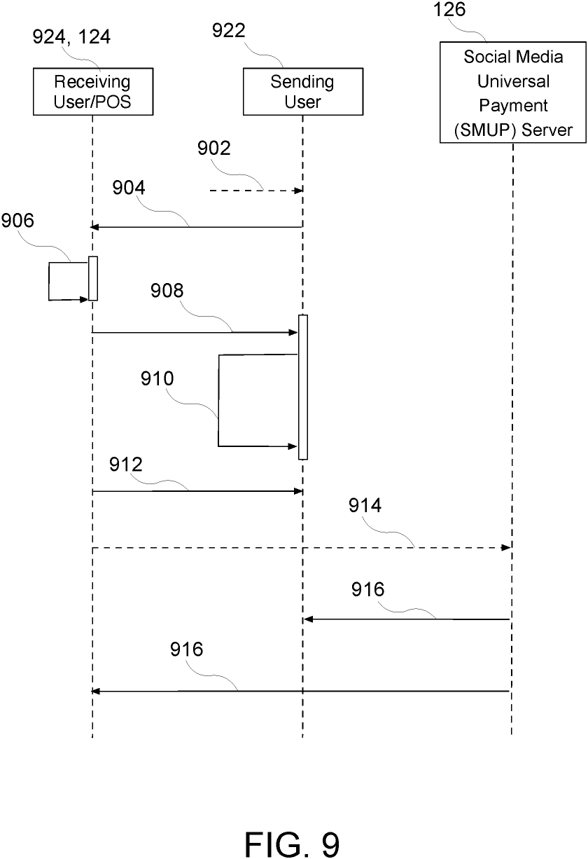

User 2 (104) is affiliated with SM/TPV 1 that is used for identity verification of user 2 (104). User 2 (104) is connected to the main cloud (116), which is linked to the SM/TPV 1 server (108) via the SM/TPV 1 cloud (106). User 2 (104) receives a link (222) originating from the POS device (124) or the website (122) of the merchant (120) via the main cloud (116). User 2 (104) presses the link (222) to complete the financial transaction. The SMUP server (126) and payment transaction server (118) are also connected to the main cloud (116). Financial transactions of FIG. 3 conducted online are discussed below in detail in reference to FIGS. 6-8. Financial transactions of FIG. 3 conducted offline are discussed below in detail in reference to FIGS. 9-11.

As noted above, FIG. 4 is a sequence diagram of the financial transaction performed according to the embodiment shown in FIG. 2. FIG. 4 is discussed herein in relation to FIG. 2. User 1′s account (202), which is actively bound to user 1′s credit card (204), is affiliated with SM/TPV 1; this user wants to transfer money to accounts of users 2 and 3 (206, 212). User 2′s account (206), which is actively bound to user 2′s credit card (208), is affiliated with SM/TPV 1 or SM/TPV 2 and receives money from user 1′s account (202). User 3′s account (212) is not registered with the SMUP server (126) and is affiliated with SM2.

As shown in FIG. 4, user 1 (202) sends a money transfer option (402) to user 2 (206). The money transfer option (402) includes a link (210) sent via email, text, or messaging through social media platforms. If user 1 (202) and 2 (206) are both affiliated with the same social media platform, user 1 (202) may send the money transfer option via that social media’s messaging. In another case, user 1 (202) and 2 (206) are affiliated with different social media platforms and user 1 knows user 2′s social media ID. In this case, user 1 (202) may send user 2′s (206) social media ID to the SMUP server (126) along with a request to transfer money. The SMUP server (126) is adaptable to locate user 2 (206) and sends the money transfer option to user 2 (206) on user 1′s (202) behalf. Regardless of user 1 (202) and 2 (206) being affiliated with the same or different social media platform, user 1 (202) can alternatively send the money transfer option via email, text, instant messaging, other suitable or equivalent methods. The SMUP server (126) is adaptable to coordinate with various social media platforms for performing and facilitating such cross-social media platform financial transactions. Just like user 1 (202), as discussed above, sends the money transfer option to user 2 (206) via various means, money transfer options can be exchanged bi-directionally by the merchant and the user for transferring money. Bi-directionally, as used herein, means that the merchant can send the money transfer option to the user, and the user can send the money transfer option to the merchant via the above-discussed means. The transactions between merchants and users are discussed in detail further below.

User 1 generates the link (210) using the SMUP server (126). In a non-limiting example, user 1 enters the name of user 2, the amount of money to be transferred, address, and/or transfer date in the SMUP server (126) using a user interface. Other information, alternate to or in addition to the information noted above, about user 2 may be entered. The SMUP server (126) checks the availability of sufficient funds in user 1′s credit card (204). Note that the SMUP server (126) interacts with the payment server (118) to determine the sufficiency of funds. The payment server (118) checks and confirms the availability of sufficient funds in their credit card (204). The payment server (118) relays this confirmation to the SMUP server (126). For simplicity, these details about the interaction between the SMUP server (126) and the payment server (118) are not described in this disclosure. Any person skilled in the art would understand the working process of the payment server (118) and its interaction with the SMUP server (126). Assuming sufficient funds are available in user 1′s credit card (204), the SMUP server (126) generates the link (210) that user 1 may send. If the funds in user 1′s credit card (204) are not sufficient, the SMUP server (126) may prompt (not shown) user 1 to choose or bind another credit card with sufficient funds.

To receive money, user 2 clicks the link (210) that sends a verification request (404) to the SMUP server (126). The SMUP server (126) checks if user 2 is registered. In a non-limiting embodiment, user 2 is identified in the registration database of the SMUP server (126) by using the information entered by user 1 to generate the link. For example, the SMUP server (126) may check the name of user 2 in the database. Once it is verified that user 2 is registered with the SMUP server (126), the identification credentials of user 2 are verified. As discussed above, the identification credentials are verified automatically or manually.

Once the identification credentials of user 2 are verified, and the money is transferred from user 1′s credit card (204) to user 2′s credit card (208). Users 1 and 2 are then notified at (412) and (410), respectively, of the completion of the financial transaction. In some embodiments of the SMUP system, if the links for transferring money remain unused for certain predetermined days or months, the links become inactive or unusable. In a non-limiting example, user 2 receives and clicks the link (210) on their mobile phone. User 2 is affiliated with SM1 and has used SM1 for verifying identification credentials during the registration process with the SMUP server (126). When user 2 clicks the link (210), user 2 is also logged into their SM1 account on their mobile phone. Because user 2 is logged into their SM1 account, identification credentials are automatically verified. If user 2 is not logged into the social media platform used during the registration process, user 2 is prompted to verify their identification credentials. For example, user 2 is prompted to log into their SM1 account to manually verify identification credentials. Open standard OAuth 2.0 or equivalent authorization protocols are used to verify identification credentials without giving out the passwords.

In another instance, user 1 (202) wants to transfer money to user 3 (212). User 1 sends a money transfer option (402) to user 3. The money transfer option (402) includes a link (218) sent via email, text, or messaging through social media platforms. User 1 generates the link (218) using the SMUP server (126). In a non-limiting example, user 1 enters the name of user 3, the amount of money to be transferred, and the date of transfer in the SMUP server (126) using a user interface. Other information, alternate to or in addition to the information noted above, about user 3 may be entered. The SMUP server (126) checks the availability of sufficient funds in user 1′s credit card (204). Assuming sufficient funds are available in user 1′s credit card (204), the SMUP server (126) generates a link (218) that user 1 may send. If the funds in user 1′s credit card (204) are not sufficient, the SMUP server (126) may prompt (not shown) user 1 to choose or bind another credit card. The process of checking the sufficiency of funds is discussed above.

To receive the money, user 3 clicks the link (218) that sends a verification request (404) to the SMUP server (126). The SMUP server (126) checks if user 3 is registered. In a non-limiting example, user 3 is identified in the registration database of the SMUP server (126) by using the information entered by user 1 to generate the link (218). In this case, user 3 is not registered with the SMUP server (126). The SMUP server (126) sends a notification (406) about the non-existent or incomplete registration to user 3. User 3 is then prompted to complete the registration (408) with the SMUP server (126); the registration process has been discussed above. User 3 provides their identification credentials (automatically or manually), as well as the required financial information to complete the registration process. FIG. 2 shows that user 3 (212) passively binds their credit card (214) and completes the registration. Once it is verified that user 3 is registered with the SMUP server (126), the money is transferred from user 1′s credit card (204) to user 3′s credit card (214). Users 1 and 3 are then notified at (412) and (410), respectively, of the completion of the financial transaction.

FIG. 5 is the flow diagram of the financial transaction performed according to the embodiment shown in FIG. 2. The flow diagram (500) starts at (502). At (504), user 1 (202) sends a link (210) or (218) to user 2 (206) or user 3 (212), respectively, for transferring money to user 2 (206) or user 3 (212). Details about the generation of the links (210, 218) are discussed above in reference to FIG. 4. As discussed above, the links (210,218) may be sent via email, text, or messaging through social media platforms. At (506), user 2 or 3 clicks their respective links (210, 218) to receive the money. At (508), the SMUP server (126) checks if users 2 or 3 are registered with the SMUP system/server (126).

In this case, user 2 is registered. At (530), after verifying that user 2 is registered, it is checked if the identification credentials of user 2 have been verified. If user 2 is not logged into the social media account, user 2 is prompted at (532) to manually verify identification credentials. As discussed above, the identification credentials may be verified automatically or manually. Once the identification credentials of user 2 are automatically or manually verified, the SMUP server (126) transfers money from user 1′s credit card (204) to user 2′s credit card (208) at step (512). At (514), users 1 and 2 receive notification of the completion of the transaction, and the flow diagram ends at (516).

In this case, user 3 is not registered. At (518), user 3 is prompted to register via passive binding. The registration process requires a user to provide identification credentials and financial information. As discussed above, the identification credentials are verified automatically or manually. At (520), user 3 passively binds the credit card (214) with the SMUP server (126). If needed (not shown), user 3 also provides identification information at (520) to complete the registration process. The registration process and passive binding have been discussed above. At (522), the SMUP server (126) determines if user 3 is registered or not. If yes, the money is transferred from user 1′s credit card (204) to user 3′s credit card (214) at (512). If the registration process cannot be completed for any reason, including but not limited to the SMUP server (126) not being able to validate the identification credentials or financial information, user 3 is notified to retry at step (524), where user 3 is diverted back to (518) to register within a predetermined number of attempts. If user 3 is unsuccessful in registering at step (522) within the predetermined attempts, user 3 is notified that the transfer request is denied and canceled at step (524); this is where they are normally notified to retry. The link (218) becomes inactive after the transfer request has been canceled at step (524). In some embodiments, user 3 may be given a predetermined number of attempts before the transfer request is canceled. This link (218) becomes inactive after the predetermined number of attempts.

If at (522), the SMUP server (126) determines that user 3 has completed the registration process successfully, the SMUP server (126) at step (512) transfers the money from user 1′s credit card (204) to user 3′s credit card (214). At (514), users 1 and 3 receive notification of the completion of the transaction, and the flow diagram ends at (516).

FIG. 6 is the sequence diagram of online financial transactions performed according to the embodiment shown in FIG. 3, wherein the user (102, 104) initiates a financial transaction with the merchant’s website from a personal computer (PC) or a mobile phone (602). The term personal computer includes a desktop computer, laptop, notebook, and other suitable devices. The term mobile phone consists of a cell phone, car phone, cellular phone, digital phone, smartphone, and other suitable devices. The user (102, 104) browses the merchant’s (120) website using the PC or mobile phone (602) and chooses a few items to purchase at (610). For example, the items are added to the website’s “Cart”, and then the user (102, 104) may proceed to “Check Out”. Once the user (102, 104) is ready to purchase the items of their choice and clicks the checkout button, the order information is sent (612) to the SMUP server (126) for verifying the merchant.

As noted above, a merchant provides identification and financial information during the registration process. The processes of the merchant’s registration and verification are discussed above in detail. The SMUP server (126) checks the contents of the order information and verifies it against the information provided at the time of registration. Once the merchant is verified, the SMUP server (126) generates a transaction number that is sent back (616) to the website (602). The transaction numbers are unique for each transaction in identifying the transaction. The merchant’s website (602) generates a scannable code (620), e.g., Quick Response Code (QR Code). At (622), the user (102, 104) scans the scannable code using a user’s device (102, 104). If the user (102, 104) views the scannable code on the PC, it can be scanned by the user’s mobile phone. If the user (102, 104) views the scannable code on the mobile phone, the scannable code may be scanned by the mobile phone itself by using suitable means. In this disclosure, the user and the user’s device are both identified interchangeably as element numbers (102, 104). After the scan, a request (624) is sent to the user’s phone (102, 104) to select the social media platform (606, 608) for identification verification purposes. As noted above, the identification credentials are verified automatically or manually.

As noted above, the social media platform includes trusted third parties to verify the user’s (102, 104) identity. If the user (102, 104) is registered, information about one or more social media platforms (606, 608) provided by the user at the time of registration is stored in the SMUP server (126). At (626), the user (102, 104) selects one of those social media platforms (606, 608) for identification purposes. The user (102, 104) is then prompted to enter authentication information, such as a password, to verify their identity. In some embodiments, if the transaction amount is below a threshold or the user (102, 104) is already logged into the selected social media platform, the registered user (102, 104) is not prompted to enter the authentication information for verifying identity.

If at (626), the user (102, 104) is not registered with the SMUP server (126), the user (102, 104) needs to complete the registration process and the passive binding that has been discussed above. The user (102, 104) is prompted to select a social media platform (606, 608) at (628). The user (102, 104) at (630) enters the password to authorize the SMUP server (126) to obtain/verify the user’s (102, 104) identification credentials. Identification credentials’ verification is discussed above. The user (102, 104) is prompted at (634) to bind a credit card passively. Once the user (102, 104) provides the financial information, the process of user registration is complete at (632).

At (628), the SMUP server (126) verifies the user’s (102, 104) identity based on the authentication information and prompts the user to select a credit card to pay for the items purchased. At (642), this information is then sent to the SMUP server (126) that transfers money from the user’s (102, 104) credit card to the merchant’s credit card. At (646) and (648), notification of completion of the online transaction is sent to the user (102, 104) and merchant, respectively, by the SMUP server (126).

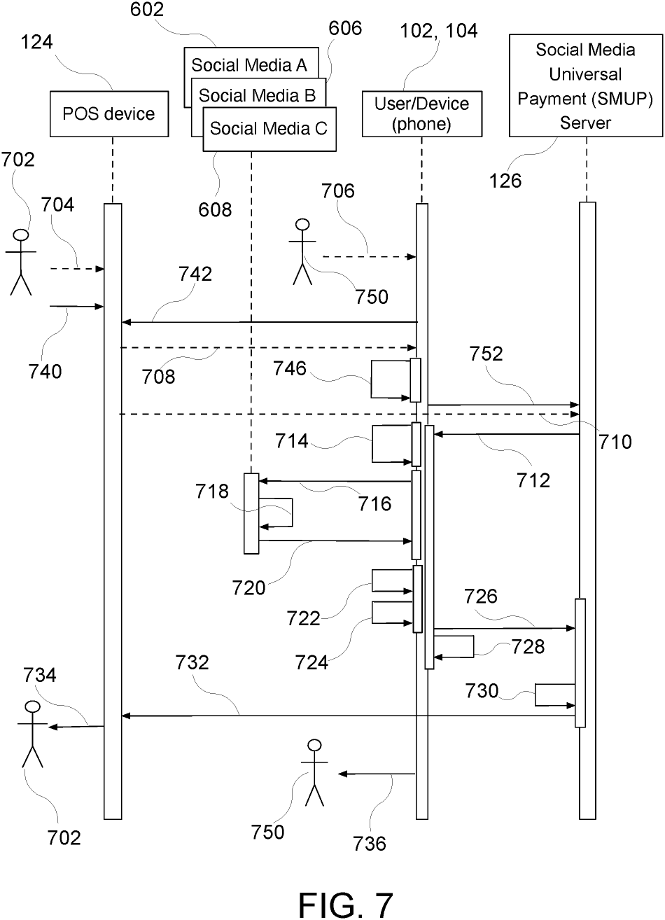

FIG. 7 is the sequence diagram of the offline financial transactions performed according to the embodiment shown in FIG. 3. The user (102, 104) visits the merchant’s brick-and-mortar store (120) to perform a financial transaction, which is performed using a point of sale (POS) device (124). In one instance, the merchant (120) wants to pay a certain amount to the user (102, 104). The cashier (702) inputs the transaction information, e.g., the desired amount for payment, into the POS device (124) at (704). A suitable software program and interface, which are required to communicate and conduct financial transactions with the SMUP server (126), are installed on the POS device (124). FIG. 7 is discussed below in reference to a quick payment mode, scan/sweep code payment mode, and static code payment mode.

In the quick payment mode, the merchant wants to pay the user, and the user (750) displays a QR code on their mobile phone (102,104) to show their identity to the cashier (702) at (706). Cashier (702) scans the QR code at (708) with the POS device (124). The transaction information, along with the QR code, is then sent to the SMUP server (126) at (710). The SMUP server (126) verifies the transaction information along with the user’s (750) QR code.

In one instance, the user (750) is registered. After the SMUP server (126) has verified the merchant’s information, the transaction information, and the user’s (750) identity, the SMUP server (126) sends an invitation to the user (750) at (712) to accept the payment. This invitation may be in the form of a link. The user (750) clicks the link and is prompted to select the social media platform (602, 606, 608) for identification at (714). The verification of identification credentials is discussed above. As the user (750) is registered, they then select the credit card for the transaction at (722). The user (750) then enters the password for the selected social media platform (602, 606, 608) and authorizes the transaction at (726). In some embodiments, the registered user (750) authorizes the transaction without entering the password at (728). For example, if the amount to be transferred is below a threshold or the user’s (750) device (102, 104) is already logged into the selected social media platform (602, 606, 608), the transaction may not need a password.

At (730), the SMUP server (126) transfers the money from the merchant’s credit card to the user’s (750) credit card. At (732), a notification of the completed financial transaction is sent to the cashier (702). In a non-limiting example, the cashier (702) views this notification on the POS device (124). The cashier (702) may choose to print a receipt for the transaction at (734). A notification of the completed transaction is also sent to the user’s (750) mobile device (102, 104), and the user (750) views that notification at (736).

In another instance, the SMUP server (126) at (712) sends the invitation to accept the payment, but the user (750) is not registered. In that case, the user (750) is prompted to select a social media platform (602, 606, 608) used by the SMUP server (126) to verify the user’s (750) identity at (716). At (718), the user (750) enters the required authentication information, such as their username and password, which provides permission at (720) to allow the SMUP server (126) to access the social media platform (602, 606, 608) to verify the user’s (750) identification. The verification of identification credentials is discussed above. At (724), the user (750) is prompted to bind the credit card information passively. At (726), the identification and financial information are sent to the SMUP server (126), and the user (750) authorizes the transaction.

At (730), the SMUP server (126) transfers the money from the merchant’s credit card to the user’s (750) credit card. At (732), a notification of the completed financial transaction is sent to the cashier (702). In a non-limiting example, the cashier (702) views this notification on the POS device (124). The cashier (702) may choose to print a receipt for the transaction at (734). A notification of the completed transaction is also sent to the user’s (750) mobile device (102, 104), and the user (750) views that notification at (736).

In the scan/sweep code payment mode, the merchant wants to pay the user, and the cashier generates a QR code that is scanned by the user’s device (102, 104). The user (750) visits the merchant’s brick-and-mortar store (120) to perform a financial transaction, which is performed using the point of sale (POS) device (124). In one instance, the merchant (120) wants to pay a certain amount to the user (750). The cashier (702) inputs the transaction information that includes the desired amount for payment into the POS device (124) at (704). A suitable software program and interface, which are required to communicate, generate QR codes, and conduct financial transactions with the SMUP server (126), are installed on the POS device (124).

In this mode, the cashier (702) at (740) then generates the QR code that is based on the transaction information on the POS device (124). The user (750) then scans the QR code with the user’s device (102, 104), such as a mobile phone, at (742). The user’s device (102, 104) at (752) sends the transaction information to the SMUP server (126). In one instance, the user (750) is registered. After the SMUP server (126) has verified the merchant’s information, the transaction information, and the user’s (750) identity, the SMUP server (126) sends an invitation to the user (750) at (712) to accept the payment. For the remaining steps in the scan/sweep code payment mode, refer to the remaining steps in the quick payment mode above after (712).

In the static code payment mode, the user (750) wants to pay for the items purchased from the merchant. At (742), the user (750) scans the QR code with the user’s device (102, 104), such as a mobile phone. The QR code does not need to be generated by the POS device (124). At (746), the user (750) enters the items selected for purchase. In some embodiments, the user (750) may enter the amount of money that needs to be transferred. The user’s device (102, 104) at (752) sends the transaction information to the SMUP server (126). One example of such payment is when the user (750) wants to pay for the food purchased at the restaurant. The user (750) looks at the menu, scans the restaurant’s QR code, selects the dishes, and pays for those dishes using the user’s device (102, 104).

In one instance, the user (750) is registered. After the SMUP server (126) has verified the merchant’s information, the transaction information, and the user’s (750) identity, the SMUP server (126) sends a message to the user at (712) to pay. This message may include a link. The user (750) clicks the link and is prompted to select the social media platform (602, 606, 608) for identification at (714). The verification of identification credentials is discussed above. As the user (750) is registered, they also select the credit card for the transaction at (722). The user (750) then enters the authentication information for the selected social media platform (602, 606, 608) and authorizes the transaction at (726). In some embodiments, the registered user (750) authorizes the transaction without entering the password at (728). For example, if the amount to be transferred is below a threshold, or the user’s device (102, 104) is already logged into the selected social media platform (602, 606, 608), the transaction may not need a password.

At (730), the SMUP server (126) transfers the money from the user’s (750) credit card to the merchant’s credit card. At (732), a notification of the completed financial transaction is sent to the merchant. In a non-limiting example, the cashier (702) views this notification on the POS device (124). The cashier (702) may choose to print a receipt for the transaction at (734). A notification of the completed transaction is also sent to the user’s (750) mobile device (102, 104), and the user (750) views that notification at (736).

In another instance, the SMUP server (126) at (712) sends the message to pay, but the user (750) is not registered. The processes of registration, the verification of identification credentials, and passive binding have been discussed above. In that case, the user (750) is prompted to select a social media platform (602, 606, 608) used by the SMUP server (126) to verify the user’s (750) identity at (716). At (718), the user (750) enters their authentication information, such as their username and password, which provides permission at (720) to the SMUP server (126) to access the social media platform (602, 606, 608) to verify the user’s (750) identification. At (724), the user (750) is prompted to bind the credit card information passively. At (726), the identification and financial information are sent to the SMUP server (126), and the user (750) authorizes the transaction.

At (730), the SMUP server (126) transfers the money from the user’s (750) credit card to the merchant’s credit card. At (732), a notification of the completed financial transaction is sent to the merchant. In a non-limiting example, the cashier (702) views this notification on the POS device (124). The cashier (702) may choose to print a receipt for the transaction at (734). A notification of the completed transaction is also sent to the user’s (750) mobile device (102, 104), and the user views that notification at (736).

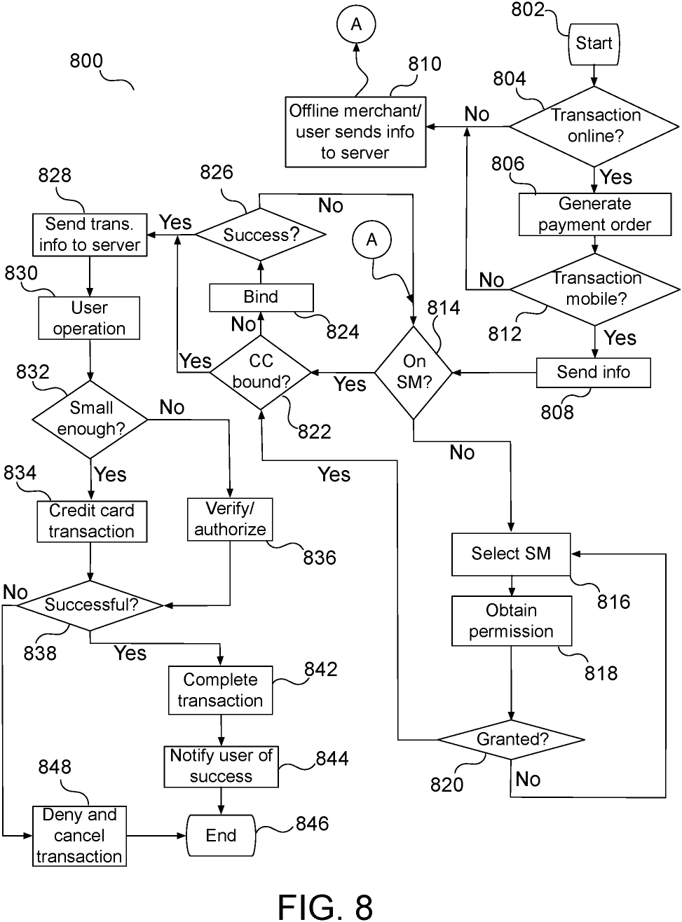

As noted above, FIG. 8 is the flow diagram of the financial transactions performed according to the embodiment shown in FIG. 3. The flow diagram starts at step (802). Step (804) determines if the transaction is being performed online or not. If yes, a payment order is generated at step (806). The payment order at step (806) includes information about the financial transaction. Step (812) determines if the transaction is being conducted on a mobile phone or not. If yes, the order information is sent to the SMUP server (126) at step (808). At step (814), the SMUP server verifies the order information received and determines if the SMUP server has the user’s social media platform information or not. If yes, i.e., the SMUP server has the user’s social media information, and the user is prompted to select a social media platform for identification purposes. The verification of identification credentials is discussed above. The SMUP server then determines at step (822) if the SMUP server has the user’s credit card information. If the user has a bound credit card, the transaction information is sent to the SMUP server for further processing at step (828).

If the credit card is not bound, the user is prompted to bind a credit card at step (824) passively. At step (826), the SMUP server verifies if the user is successful in binding the card. If the user is unsuccessful in binding the card, the user is reverted to step (814). In some embodiments (not shown), the user is reverted to step (822). If the user successfully binds the card, the transaction information is sent to the SMUP server for further processing at step (828).

If it is determined that the SMUP server does not have the user’s social media information at step (814), i.e., the user is not registered, the user is prompted to select a social media platform at step (816). At step (818), the user then enters the password to authorize the SMUP server to obtain the user’s identification credentials, such as user name and password, from the social media platform. If the social media platform grants permission at step (820), the user’s identification credentials are verified. The verification of identification credentials is discussed above. In that case, the SMUP server determines at step (822) if the SMUP server has the user’s credit card information. If the social media platform does not grant permission at step (820) and/or the user’s credentials are not verified, the user is reverted to step (816). Here, the user is prompted once again to select the social media platform.

If the transaction at step (804) is not being conducted online, then at step (810), the offline merchant/user sends the transaction information to the SMUP server. The SMUP server verifies the transaction/order information received and, as discussed above, determines at step (814) if the SMUP server has the user’s social media platform information or not.

Once it is verified that the user is registered at steps (822) and (826), the transaction information is sent to the SMUP server at step (828). At step (830), the SMUP server prompts the user to authorize the transaction. In some embodiments, if the transaction is within a threshold limit or the user is already logged into the selected social media platform, the transaction is automatically authorized without the registered user’s intervention, e.g., without requiring the user’s password. Step (832) determines if the transaction is within the threshold limit. If yes, step (834) carries out the credit card transaction. If not, the user must verify their identification credentials to authorize the payment at step (836). At step (838), if the transaction is determined to be successful, the transaction is completed at step (842). At step (844), the merchant and the user are notified of the completed transaction, and the process ends at step (846). At step (838), if the transaction is determined to be unsuccessful, the transaction is denied and/or canceled at step (848), and the process ends at step (846).

FIG. 9 is the sequence diagram of a financial transaction performed according to the embodiment shown in FIG. 3, wherein both parties are offline and not connected to the SMUP server (126) at the time of the transaction. In this transaction, a sending user (922) wants to pay some money to a receiving user (924) or the POS device (124). Both parties of the transaction, i.e., the sending user (922) and receiving user/POS device (924, 124), have the program/software installed on the users’ (922, 924) mobile phone and merchant’s POS (124). As noted above, the program/software may be in the form of a plugin. As their identification, the sending user (922) displays a QR code generated by the program/software on their mobile phone at (902). In some embodiments, the QR code is a payment code that shows the sending user’s (922) intent to pay and includes the user’s identification information. The receiving user (924) or POS device (124) scan the QR code at (904). At (906), the receiving user (924) enters the amount to be transferred from the sending user (922) to the receiving user (924). In the case of a merchant, a cashier enters the transaction information at (906), such as the number & cost of items purchased, tax, etc.

At (908), the sending user (922) is requested to authorize the transaction. At (910), in a non-limiting example, the receiving user (922) authorizes the transaction by signing, leaving a voice/video recording either on the receiving user’s (924) mobile phone or the merchant’s POS (124) terminal. In other embodiments, as part of authorizing the transaction, the program/software verifies the user’s identification credentials automatically or manually, which are discussed above. Any person skilled in the art may use SMS, biometric, or other suitable means for identification verification. At (912), the receiving user (924)/POS device (124) generates a payment receipt for the sending user (922). In one example, the sending user (922) takes a picture or an image of the payment receipt as proof of the transaction. At (914), whenever the receiving user (924)/POS device (124) is connected to the SMUP server (126), the transaction information is transferred to the SMUP server. Once the transaction information and the associated details/credentials are verified, the money is transferred from the sending user’s (922) credit card to the receiving user’s (924) credit card or merchant’s credit card. The SMUP server (126) then, at (916), sends a transaction completion notification to the user (922) and the user (924)/POS device (124).

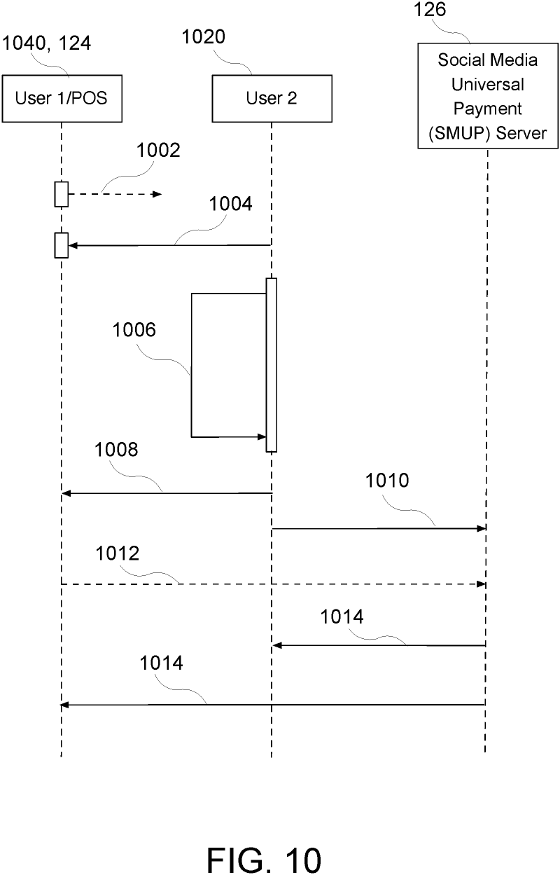

FIG. 10 is a sequence diagram of a financial transaction performed according to the embodiment shown in FIG. 3, wherein both parties are offline and not connected to the SMUP server at the time of the transaction. In this transaction, user 2 (1020) wants to pay user 1 (1040) or the POS (124) a certain amount of money. Both parties of the transaction, i.e., user 2 (1020) and user 1/POS (1040/124), have the program/software installed on the users’ (1020, 1040) mobile phone and merchant’s POS (124). As noted above, the program/software may be in the form of a plugin. Unlike FIG. 9, user 1 (1040) or POS (124) displays a QR code generated by the program/software on their mobile phone/POS device at (1002). In some embodiments, the QR code is a collection code that is displayed to user 2 (1020). At (1004), user 2 (1020) scans the QR code using their mobile device.

At (1006), user 2 (1020) is prompted to enter the transaction details. The transaction details may include the amount to be transferred from user 2 (1020) to user 1 (1040) or the POS (124), number & cost of items purchased, tax, etc. User 2 (1020) is also prompted to authorize the transaction, and user 2 (1020) authorizes the transaction at (1006). The authorization process and verification of identification credentials are discussed above in reference to FIG. 9. At (1008), user 2 (1020) generates the transaction authorization information receipt on their mobile device. User 1 (1040) or the POS (124) takes a photo of the transaction authorization information receipt as proof of the transaction. Whenever user 2 (1020) gets connected to the SMUP server (126), e.g., via the internet, the details of the transaction authorization information receipt are uploaded to the SMUP server (126) at (1010). The SMUP server (126) then verifies the transaction authorization information. After the authorization information, authentication credentials, and financial information related to both parties of the transaction are confirmed, the money is transferred from user 2′s (1020) credit card to the credit card of user 1 (1040) or the POS (124).

In case user 2 (1020) is unable to connect to the SMUP server (126), at (1012), user 1 (1040) or the POS (124) may upload the photo of the transaction authorization information receipt as proof of the transaction. The SMUP server (126), upon verification of the information and as described above, transfers the money from user 2′s (1020) credit card to the credit card of user 1 (1040) or the POS (124). This enables user 1 (1040) or the POS (124) to receive payment even if user 2 (1020), inadvertently or intentionally, fails to upload the transaction information to the SMUP server (126). Once the money is successfully transferred and the transaction is completed, a notification of the transaction completion is sent at (1014) to user 2 (1020) and user 1 (1040)/POS (124).

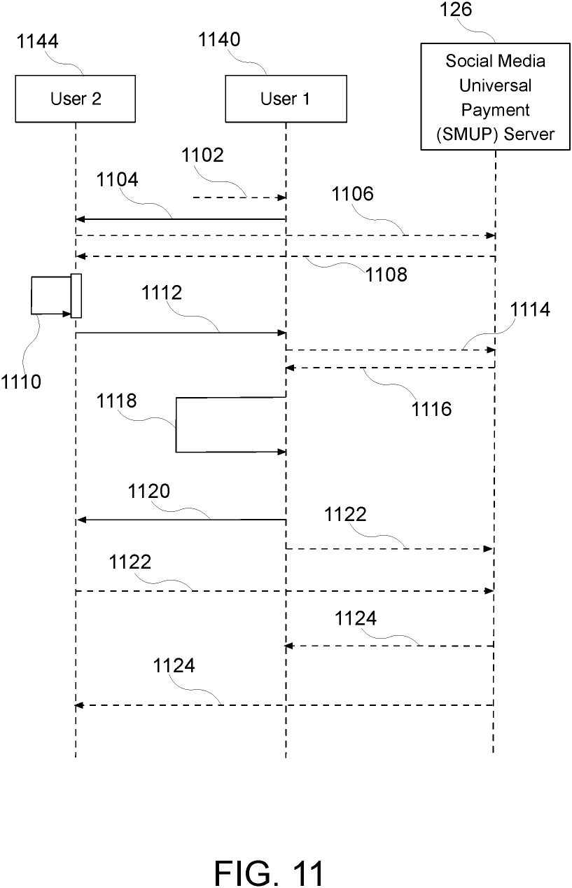

FIG. 11 is the sequence diagram of a financial transaction performed according to the embodiment shown in FIG. 3, wherein one party of the financial transaction is not connected to the SMUP server at the time of the transaction. In this transaction, user 1 (1140) wants to transfer money to user 2 (1144). At (1102), user 1 (1140) displays a QR code generated by the program/software on their mobile phone. In some embodiments, the QR code is a payment code that shows user 1′s (1140) intent to pay and includes the user’s identification information. User 2 (1144) scans the QR code at (1104).

In one example, only user 2 (1144) is connected to the SMUP server (126) during the transaction, e.g., via the internet, wireless, etc. At (1106), user 2 (1144) sends the user’s identification information to the SMUP server (126) for verification. At (1108), the SMUP server (126) confirms user 1′s (1140) identification and sends it to user 2′s (1144) mobile device/POS. At (1110), user 2 (1144) enters the amount to be transferred from user 1 (1140) to user 2 (1144). In the case of a merchant, at (1110), a cashier enters the transaction information, such as the number & cost of items purchased, tax, etc.

At (1112), user 1 (1140) is requested to authorize the transaction. In some embodiments, user 2′s (1144) identification credentials are verified as part of authorizing the transaction. The verification of identification credentials is discussed above. At (1118), in a non-limiting example, user 1 (1140) authorizes the transaction by signing, leaving a voice/video recording either on user 2′s (1144) mobile phone or the POS terminal. At (1120), user 2 (1144) generates a payment receipt for user 1 (1140). In one example, user 1 (1140) takes a picture or an image of the payment receipt as proof of the transaction. At (1122), whenever user 2 (1144) gets connected to the SMUP server (126), the transaction information is transferred to the SMUP server (126).

In one instance, user 1 (1140) may connect to the SMUP server (126) and upload the payment receipt picture or an image. Thus, either party of the transaction can get connected to the SMUP server (126) after the transaction and can complete the transaction by uploading the related information to the SMUP server (126). Once the transaction information and the associated details/credentials are verified, the money is transferred from user 1′s (1140) credit card to user 2′s (1144) credit card. The SMUP server (126) then, at (1124), sends a transaction completion notification to user 1 (1140) and user 2 (1144).

In another example, only user 1 (1140) is connected to the SMUP server (126) during the transaction. In that case, steps (1102), (1104), (1110), and then (1112), as discussed above, are performed. At (1114), user 1 (1140) sends the transaction information for verification to the SMUP server (126). At (1116), the SMUP server (126) verifies the information and sends the confirmation to user 1 (1140).

At (1118), user 1 (1140) authorizes the transaction on their mobile device and, at (1120), generates a payment receipt for user 2 (1144). In one example, user 2 (1144) takes a picture or an image of the payment receipt as proof of the transaction.

Because user 1 (1140) is connected to the SMUP server (126), at (1122), confirmation of the transaction authorization is sent to the SMUP server (126). User 2 (1144) also can connect to the SMUP server (126) and upload the picture or an image of the payment receipt. Thus, either party to the transaction can get connected to the SMUP server (126) after the transaction and can complete the transaction by uploading the related information to the SMUP server (126). Once the transaction information and the associated details/credentials are verified, the money is transferred from user 1′s (1140) credit card to user 2′s (1144) credit card. Then the SMUP server (126), at (1124), sends a transaction completion notification to user 1 (1140) and user 2 (1144).

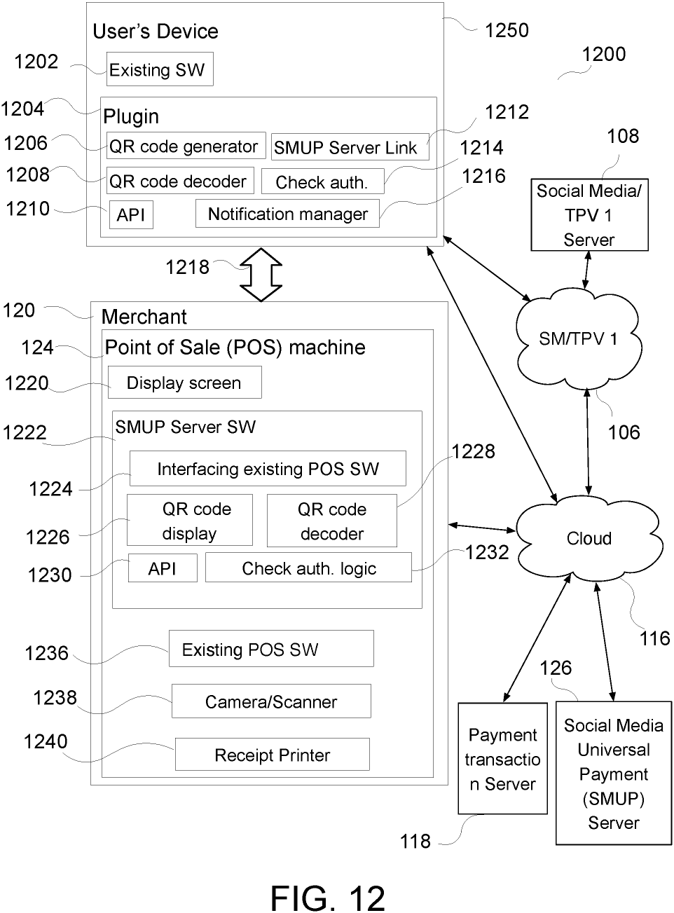

FIG. 12 is the block diagram (1200) of the SMUP system with details of the user’s device (1250) and a commercial entity’s (e.g., merchant (120)) point of sale (POS) machine (124). The user’s device (1250) is used by the user (102, 104, 110) for performing a financial transaction described in this disclosure. The user’s device (1250) may be a mobile phone. As noted above, the term mobile phone includes a cell phone, car phone, cellular phone, digital phone, smartphone, and any other suitable devices. Existing software (1202) is installed on the user’s device (1250). In a non-limiting example, the existing software (1202) may be factory-installed/pre-installed software on a mobile phone bought from an original equipment manufacturer (OEM).

The plugin (1204) for the SMUP program/software is installed on the user’s device (1250). The plugin (1204) is a software add-on that is installed along with the existing software (1202) on the user’s device (1250). The plugin (1204) includes, but is not limited to: a QR code generator (1206), a QR code decoder (1208), a SMUP server link (1212), a check authentication logic (1214), a notification manager (1216), and an application programming interface (API) (1210). The QR code generator (1206) generates a QR code that is displayed on the user device’s (1250) screen. One example of the QR code generated by the QR code generator (1206) is the payment code that shows the user’s intent to pay and includes the user’s identification information.

The QR code decoder (1208) enables the user to scan a QR code. For example, the QR code decoder (1206) enables the user to scan a collection code of a merchant (120). The collection code includes information about the merchant’s (120) identification and the merchant’s (120) intent to receive money from the user. The SMUP server link (1212) makes the user’s device (1250) accessible to the SMUP server (126) and enables the communication between the user’s device (1250) and the SMUP server (126) via the main cloud (116). The check authentication logic (1214) provides another tool for the user’s verification. For example, a code is generated by the SMUP server (126) as part of a two-factor authentication of the user. The user inputs that code into the user’s device (1250). The check authentication logic (1214) verifies that code to ensure that no one other than the user is using the device (1250) and/or doing the transaction.

The API (1210) is a computing interface that defines the interactions between the existing software (1202) and the plugin (1204). The API (1210) defines how different applications can interact with and obtain data from one another. The notification manager (1216) provides a means of delivering a message from the SMUP server (126) to the user and vice versa, or between the user’s device (1250) and the POS (124).

The point of sale (POS) machine (124) includes, but is not limited to, a display screen (1220), SMUP server software (SW) (1222), existing POS software (1236), a camera/scanner (1238), and a receipt printer (1240). The SMUP server software (1222) includes interfacing existing POS software (1224), QR code display/generator (1226), QR code decoder (1228), API (1230), and check authentication logic (1232). The display screen (1220) enables a merchant (120) to display information related to a financial transaction visually. The display screen (1220) may also include pressure sensitivity to enable inputting data. For example, the display screen (1220) displays a prompt/collection code, and a cashier/user can use the display screen (1220) to input data related to that prompt.

The SMUP server SW (1222) may be installed in the form of a plugin in the POS (124). The interfacing existing POS SW (1224) defines interactions between the existing POS SW (1236) and the SMUP server SW (1222). The QR code display generator (1226), QR code decoder (1228), API (1230), and check authentication logic (1232) of the SMUP server SW (1222) work similarly to the QR code generator (1206), QR code decoder (1208), API (1210), and check authentication logic (1214), respectively, of the plugin (1204) that is discussed in detail above. The existing POS SW (1236) installed on the POS (124) is factory-installed/pre-installed software. The POS (124) also has a camera/scanner (1238) used to scan a QR code, item code, etc. The receipt printer (1240) prints various payments, such as financial transactions, credit card slips, customer slips, payment decline receipts, etc.

The link (1218) represents a communication link between the user’s device (1250) and the POS (124). Non-limiting examples of this form of communication are the user’s device (1250) displaying a payment code to the POS (124), the POS (124) displaying a collection code to the user’s device (1250), and the user’s device/POS (124) taking a picture/image of the payment receipt. Details about the SM/TPV 1 server (108), SM/TPV 1 cloud (106), cloud (116), payment transaction server (118), and the SMUP server (126) may be referred to above, wherein these details are discussed in reference to the other figures.

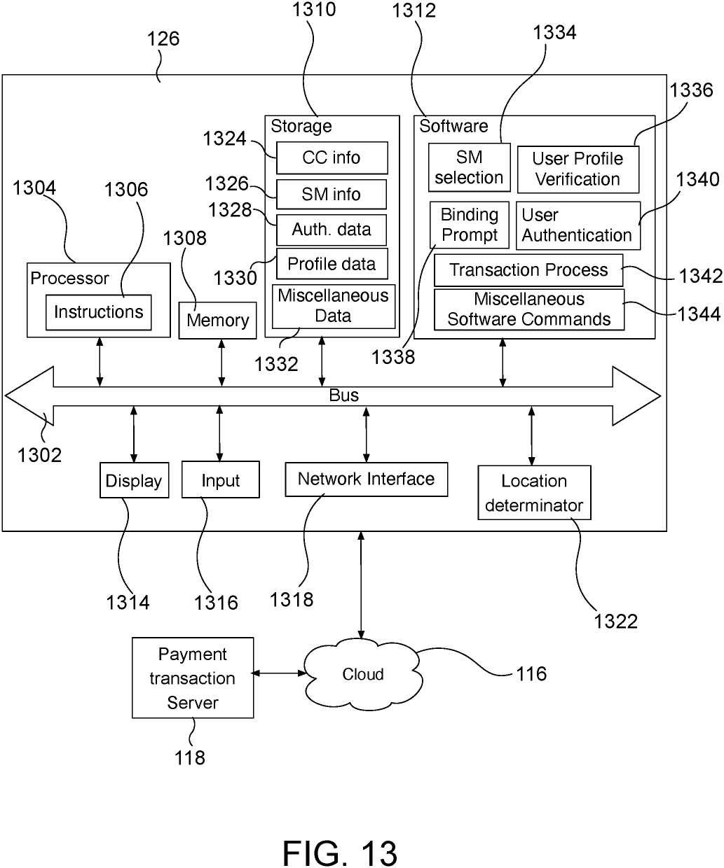

FIG. 13 is the block diagram showing details of the SMUP server (126). The SMUP server (126) includes, but is not limited to, a processor (1304), memory (1308), storage means (1310), software (1312), display (1314), input means (1316), a network interface (1318), and a location determinator (1322). These elements are connected to a bus (1302) that enables the communication between these elements. The SMUP server (126) contains a motherboard (not shown) that is the server’s main electronic circuit board to which all the other components of the server are connected. The processor (1304) contains a central processing unit and computer instructions (1306) adapted for the CPU’s functioning. The memory (1308) comprises random access memory (RAM), and the storage means (1310) comprises hard drives, such as SATA, SSD, SSHD, HDD. The credit card information (1324), social media (SM) information (1326), authentication data (1328), user profile data (1330), and miscellaneous data (1332) related to the users and merchants are stored in the storage means (1310).

The software (1312) comprises computer instructions adapted for social media (SM) selection (1334), user profile verification (1336), binding prompt (1338), user authentication (1340), transaction process (1342), and miscellaneous software commands (1344). The SM selection (1334) contains instructions to enable the registered user to select the social media platform based on the information in the SM information (1326). The binding prompt (1338) includes instructions for prompting a user to provide identification credentials for verification and financial information for money transfer. The user profile verification (1336) contains instructions for verifying the user’s identity (e.g., automatic or manual) and financial information based on the credit card information (1324) and SM information (1326). The user authentication (1340) includes instructions for using the required authentication information, such as password, CVV code, security questions, etc., provided by the user to verify the user’s identity and perform financial transactions. It should be noted that the user profile verification (1336) and the user authentication (1340) are not limited to the user as used in this disclosure; they can also include instructions adapted for a merchant’s verification and merchant’s authentication, respectively. Similarly, other elements of the SMUP server (126) apply both to the user as well as the merchant of this disclosure.

The transaction process (1342) contains instructions for transferring money from one credit card account to another. The transaction process (1342) includes instructions for interacting with the payment transaction server (118) based on the data stored in the credit card information (1324). Miscellaneous software commands (1344) contain instructions for performing other tasks needed for the functioning of the SMUP server (126). Any person skilled in the art would understand and make use of the miscellaneous software commands (1344) in reference to the SMUP server (126). The display (1314) is an output device that displays information and includes LCD and LED monitors. The input (1316) is an input device such as a keyboard, mouse, touchpad, touchscreen, etc. The network interface (1318) is a software or hardware interface between the SMUP server (126) and the main cloud (116) for providing standardized functions such as passing messages, connecting, and disconnecting. Some embodiments have the location determinator (1322) to determine the user/merchant’s geographical location for verification purposes. For example, the SMUP server (126) receives transaction information for verification from a POS device installed at a store where a user purchases an item. The user uses their mobile phone to make this purchase. The SMUP server (126) uses the location determinator (1322) to ascertain the mobile phone’s geographical location inside or in the vicinity of the store. The location is used as a security factor to confirm the identity of the user.

The SMUP (126) shown in FIG. 13 is used according to the embodiments shown in FIGS. 1-12 and described in the disclosure above to provide an accurate, reliable, flexible, and user-friendly user identification method for enabling easy financial transactions between the users and entities as well as among different users. The SMUP (126) system, according to this disclosure, eliminates the need for repetitive identity verification and a multitude of authentication mechanisms.

The terms and expressions which have been employed herein as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1. A method for processing digital payments through the Internet, comprising:
providing a payment server; wherein the payment server receives payment requests from a first user for transferring money to a second user; wherein the first and second user has one or more financial accounts and at least one of the first and second users has one or more third-party social media accounts;
during a registration process,
the first and second users providing their social media information if any by verifying their identification credentials through their respective social media accounts and/or providing their respective financial accounts information to the payment server;
the server receiving a confirmation of the verified identification credentials from the social media accounts and/or financial accounts from the first and second users; their financial accounts are bound to their social media accounts or directly to their payment accounts;
the server registering a first payment account for the first user and a second payment account for the second user, and storing the information in the server;
during a money transfer process,
the first user initiating generation of a payment request for transferring money from the first user’s payment account to the second user’s payment account and/or selecting one of his/her financial accounts from which to transfer money to the second user;
the payment server verifying the first user’s identification credentials from his/her social media account using the saved information, generating the payment request, and sending the payment request to the second user;
the second user receiving the payment request and/or selecting one of his/her financial accounts for receiving money;
the payment server verifying the second user’s identification credentials from his/her social media account using the saved information, transferring money from the first user’s payment account through the selected financial account to the second user’s payment account or the selected financial account to complete the payment request and update the balance of all related account.

2. The method of claim 1, wherein the identification credential verification of the third-party social media accounts is performed automatically through OAuth 2.0 protocol, token or manually by inputting username, password, CVV code, PIN, security question, or verification code.

3. The method of claim 1, wherein at least one of the financial accounts has been already associated with the social media account.

4. The method of claim 1, wherein the first user has a first social media account and the second user has a second social media account; the digital payment works no matter the first and second social media accounts belong to one same social media network or two different social media networks.

5. The method of claim 1, wherein the financial account can be a bank account or credit card.

6. The method of claim 1, wherein the payment can be completed online on a PC, mobile, or device, or offline on a POS, PC, mobile, or device.

7. The method of claim 1, wherein at least one of the first and second users has installed a customized application software for facilitating said digital payment processing; wherein the payment request is in the forms of QR codes, bar codes, or links.

8. The method of claim 1, wherein one of the first and second users is a merchant, store, institution, restaurant, or other business.

9. The method of claim 1, further comprising the payment server transmitting a completion report of the payment request to the first and/or second user at the end.

10. A method for processing digital payments through the Internet, comprising:
providing a payment server; wherein the payment server receives payment requests from a first user for transferring money to a second user; wherein the first and second user has one or more financial accounts and at least one of the first and second users has one or more third-party social media accounts;
during a registration process,
the first user providing his/her social media information by verifying his/her identification credentials through his/her respective social media account;
the server receiving a confirmation of the verified identification credentials from the social media account and/or financial account from the first user; his/her financial accounts are bound to the social media account or directly to the payment account;
the server registering a payment account for the first user, and storing the information in the server;
during a money transfer process,
the first user initiating generation of a payment request for transferring money from the first user’s payment account to the second user and/or selecting one of his/her financial accounts from which to transfer money to the second user, or vice versa;
the payment server verifying the first user’s identification credentials from his/her social media account using the saved information, generating the payment request, and sending the payment request to the second user through a communication channel;
the second user receiving the payment request and/or selecting one of his/her financial accounts for receiving money;
the payment server prompting the second user to register for a payment account during the money transfer time and verifying the second user’s identification credentials from his/her respective social media account if any; his/her financial accounts are bound to the social media account or directly to the payment account;
the payment server verifying the second user’s identification credentials from his/her social media account using the saved information, transferring money from the first user’s payment account through the selected financial account to the second user’s payment account or the selected financial account to complete the payment request and update the balance of all related account.

11. The method of claim 10, wherein the first user is a merchant, store, institution, restaurant, or other business.

12. The method of claim 7, wherein at least one of the first and second users temporarily loses connection to the payment server during the money transfer time, if both the first and second users already have a payment account, then the digital payment can still be completed by storing the transaction balances locally and synchronizing with the payment server after the connection is restored.

13. The method of claim 11, wherein at least one of the first and second users temporarily loses connection to the payment server during the money transfer time, if the second user already has a payment account, then the digital payment can still be completed by storing the transaction balances locally and synchronizing with the payment server after the connection is restored.

14. The method of claim 11, wherein the first and second users meet in person during the money transfer time.

15. An online system for processing digital payments, comprising:
a payment server that receives payment requests from a first user for transferring money to a second user, or vice versa; wherein the first and second user have one or more financial accounts and at least one of the first and second users has one or more third-party social media accounts;
a user registration process comprising:
the first and second users providing their social media information if any by verifying their identification credentials through their respective social media accounts and/or providing their respective financial accounts information to the payment server;
the server receiving a confirmation of the verified identification credentials from the social media accounts and/or financial accounts from the first and second users; their financial accounts are bound to their social media accounts or directly to their payment accounts;
the server registering a first payment account for the first user and a second payment account for the second user, and storing the information in the server;
a money transfer process comprising:
the first user initiating generation of a payment request for transferring money from the first user’s payment account to the second user’s payment account, or vice versa, and/or selecting one of his/her financial accounts for the money transfer;
the payment server verifying the sending user’s identification credentials from his/her social media account using the saved information, generating the payment request, and sending the payment request to the receiving user;
the receiving user receiving the payment request and/or selecting one of his/her financial accounts for receiving money;
the payment server verifying the receiving user’s identification credentials from his/her social media account using the saved information, transferring money from the sending user’s payment account through the selected financial account to the receiving user’s payment account or the selected financial account to complete the payment request and update the balance of all related account.

16. The system of claim 15, wherein the receiving user registers for a payment account in the payment server during the money transfer time.

17. The system of claim 15, wherein the first user has a first social media account and the second user has a second social media account; the digital payment works no matter the first and second social media accounts belong to one same social media network or two different social media networks.

18. The system of claim 15, wherein at least one of the first and second users has installed a customized application software for facilitating said digital payment processing; wherein the payment request is in the forms of QR codes, bar codes, or links.

19. The system of claim 18, wherein one of the first and second users is a merchant, store, institution, restaurant, or other business and the first and second users can all be online or meet in person during the money transfer time.

20. The system of claim 19, wherein at least one of the first and second users loses connection to the payment server during the money transfer time, if both the first and second users already have a payment account on the payment server, then the digital payment can still be completed by storing the transaction balances locally and synchronizing with the payment server after the connection is restored.
